(19) United States
(12) Patent Application Publication
(10) Pub. No.: US 2019/0244432 A1
(43) Pub. Date: Aug. 8, 2019

(54) EXHIBITION SYSTEM ARRANGED FOR PRESENTING A MIXED REALITY AND A METHOD OF USING SAID SYSTEM

(71) Applicant: Realfiction ApS, København Ø (DK)

(72) Inventor: Peter Allan SIMONSEN, København K (DK)

(73) Assignee: Realfiction ApS, København Ø (DK)

(21) Appl. No.: 16/314,791

(22) PCT Filed: Jun. 28, 2017
(86) PCT No.: PCT/EP2017/065953

§ 371 Date: Jan. 2, 2019

(30) Foreign Application Priority Data
Jul. 5, 2016 (DK) PA201670493
Feb. 6, 2017 (DK) PA201770069
Mar. 9, 2017 (DK) PA201770169
May 3, 2017 (DK) PA201770300

(51) Int. Cl. G06T 19/00; G02B 27/22; G02B 27/01; G02B 5/10

(52) U.S. Cl. CPC G06T 19/006; G02B 27/2235; G02B 27/0101; G02B 2027/0185; G02B 2027/014; G02B 2027/0127; G02B 5/10

(57) ABSTRACT

An exhibition system configured to hold at least one image source or including at least one image source. The image source is arranged for projecting at least one image onto at least one concave semi-transparent reflector providing a magnified representation appearing in the distance beyond the semi-transparent reflector. The system has an adjuster for adjusting the distance between the concave semi-transparent reflector and the first image source and/or angle between the concave semi-transparent reflector and the first image source. The system enables the combination of the real world with magnified images, e.g. from video processing and computer vision techniques, offering a natural view of real scenes enriched with “real size” virtual objects.

The present invention relates to an exhibition system for presenting a mixed reality. More specifically the present invention relates to an exhibition system for superimposing images e.g. video, motion pictures and the like, on the real world.

Illusions have been widely used for decades, for example to create special effects in theatres and exhibitions.

As commercials, shop displays and exhibitions are becoming increasingly more advanced, such illusions are to a larger extend becoming part of our everyday life. However, there remains a continuous competition to achieve the attention of users and customers, and museums and trade exhibitioners are experiencing rising demands to offer alternative and new ways for the visitors to obtain advanced information especially in “real-size”.

Presenting real-size products is of course not a problem as such for smaller products, but as soon as the products exceed a certain size, numerous problems in relation to logistics begin to arise, e.g. due to the obvious limitation on how many planes, trucks etc. that can be placed in e.g. an exhibition hall.

A similar problem exists in many museums and similar institutions. First of all, most museums do not have the space and resources required to exhibit their whole collections. In addition, the nature and fragility of some objects prevent museum curators from making them available to the public.

In this respect, virtual and augmented reality can offer a great help. These technologies provide solutions enabling visualization of 3D digital models of trade goods, museum artefacts and the like in both virtual and real environments.

As an example of an illusion used to promote products at e.g. exhibitions can be mentioned, the Dreamoc® XL system obtainable from Realfiction ApS, Denmark, which is a mixed-reality display designed to present products or objects in combination with free floating video elements. Thus, using this technology it is possible to combine physical objects with video and computer graphics, thereby transforming an otherwise trivial product into an entertaining and impressive experience for the viewer.

In these known displays, different image sources are arranged for projecting digital content, e.g. video elements, onto angled semi-transparent mirrors forming at least a part of a pyramid, thereby ensuring that the video elements are superimposed on an actual physical object.

However, there is a number of physical limitations as to the size of such displays, as said technology requires physical elements having a size which correlates to the size of the image that are to be shown. Thus, it is not possible to present large real-size products, unless very large displays are used.

A different way of combining the real world with digital images can be obtained using optical see-through system, e.g. when a user wears a head mounted display that has the capability of reflecting projected images as well as allowing the user to see the real would simultaneously. This will provide an augmented/mixed reality, i.e. a direct view of a physical, real-world environment whose elements are augmented (or supplemented) by computer-generated sensory input such as sound, video and/or graphics.

However, in such optical see-through systems the image that are to be “superimposed” on the real world, are only visual on the display screen, e.g. on the display of the head mounted display and the size of the image can therefore only be altered by changing the size of the displayed image. This provides a number of disadvantages as the size of the digital image cannot be adapted to that of the real world, as said image will have the same size irrespectively of the surroundings, and the augmented/mixed reality will therefore not be perceived as “real”.

Furthermore, in order to obtain the full benefits of these optical see-through systems, the user has to wear the head mounted display at all times, and observe the augmented reality though said display. Even though the user, when wearing the head mounted display, will perceive the augmented reality, there exists a number of situations where the use of such displays are not desirable and/or appropriate. For instance, as the world is viewed through the head mounted display, it will be difficult to interact with other persons. Furthermore, at e.g. exhibition halls and museums, having both normal exhibitions and mixed reality exhibition, the user has to remove the display, or put it back on, depending on which exhibition he/she is viewing. This is both time-consuming and annoying for the user, especially in e.g. museums and/or trade exhibitions, and will be an almost insurmountable challenge for the companies/persons presenting the exhibitions as well as being extremely expensive.

Furthermore, in museums and/or trade exhibitions it is often preferably to be able to visualize the desired object(s) in real size, as part of an exhibition without using expensive large size displays and/or special personalized gear.

Thus, it is a first aspect of the present invention to provide an exhibition system which can superimpose a large scale image on the real world without distortion, and wherein the system is relatively small in size compared to the images viewed.

It is a second aspect of the present invention to provide an exhibition system, which easily can be customized and altered in relation to a new product to be viewed.

It is a third aspect of the present invention to provide a display, which is easy and simple to operate, and which does not require that the user wears or uses special personalised equipment.

It is a aspect of the present invention to provide an exhibition system, which requires less maintenance than the conventional displays.

It is a fifth aspect of the present invention to provide a simple exhibition system which can be easily assembled, used, and adjusted without requiring skill or training.

An exhibition system for presenting a mixed reality is disclosed. The exhibition system is configured to hold an image source or the system comprises an image source. The image source is arranged for projecting at least one image onto at least one concave semi-transparent reflector thereby providing a magnified representation of the image, i.e. providing a virtual image, appearing in the distance beyond the semi-transparent reflector. The system comprises adjustment means for adjusting the distance between the concave semi-transparent reflector and the image source and/or angle between the concave semi-transparent reflector and the image source.

In some embodiments, the magnified representation of the image behind said semi-transparent reflector is magnified at least 1.5 times the size of the image displayed by the image source, preferably at least 8 times, and even more preferably at least 2000 times the size of the image displayed by the image source.

In some embodiments, the size of the concave semi-transparent reflector is between about 100×200 mm and about 12×24 m.

In some embodiment the size of the concave semi-transparent reflector is between about 200×400 mm and about 12×24 m.

In some embodiments the size of the concave semi-transparent reflector is between about 200×400 mm and about 3000×3000 mm.

In some embodiments, the size of the concave semi-transparent reflector is between about 800×800 mm and about 2000×2000 mm.

In some embodiments, the concave semi-transparent reflector has an inner surface facing the image source with a radius of curvature between 1000 mm and 8000 mm.

In some embodiments, the concave semi-transparent reflector has an inner surface facing the image source with a radius of curvature between 2200 mm and 5000 mm, preferably about 2800 mm.

In some embodiments, the inner and outer surfaces of the concave semi-transparent reflector have substantially identical radii of curvature.

In some embodiments, the exhibition system is arranged such that the distance between the concave semi-transparent reflector and the image source cannot exceed the focal length of the concave semi-transparent reflector.

In some embodiments, the reflection layer of the semi-transparent reflector is the inner side of the concave semi-transparent reflector facing the image source.

In some embodiments, the concave semi-transparent reflector is placed at an angle of between 5 and 25 degrees in relation to the surface/base the system is placed upon.

In some embodiments, the adjustment means is arranged for manually changing the distance and/or angle between the concave semi-transparent reflector and the image source.

In some embodiments, the adjustment means comprises a connecter, to which the image source is attached, at least one longitudinal track in which the position of the connecter can be adjusted by slinging it back and forth along said track, and a fastening means for fastening the connecter at different positions along the track(s).

In some embodiments, the adjustment means are arranged for automatically changing the distance and/or angle between the concave semi-transparent reflector and the image source.

In some embodiments, the exhibition system comprises means for adjusting the transparency of the concave semi-transparent reflector, and wherein the transparency of said reflector can be adjusted from being completely opaque to being between about 30 and 50% transparent.

In some embodiments, the concave semi-transparent reflector is arranged as a smart window.

In some embodiments, the means for adjusting the transparency of the concave semitransparent reflector is a smart window, placed behind the concave semi-transparent reflector seen in a position of use.

In some embodiments, the means for adjusting the transparency of the concave semi-transparent reflector comprises a polarizing filter(s) arranged for being rotated to a rotational angle that control the intensity of the light coming though the concave semi-transparent reflector.

In some embodiments, the exhibition system comprises means for controlling the brightness of the image displayed by the image source.

In some embodiments, the image source is a conventional display, e.g. an LCD or an OLED.

In some embodiments, the image source is a concave image source, preferably a flexible OLED display.

In some embodiments, the exhibition system is modified in that the system comprises at least two image sources, and wherein at least one of these image sources is a concave semi-transparent image source.

In some embodiments, the at least one concave semi-transparent image source has a radius of curvature corresponding substantially to the radius of curvature of the concave semi-transparent reflector.

In some embodiments, the at least one concave semi-transparent image source has a radius of curvature which is smaller than the radius of curvature of the concave semi-transparent reflector.

In some embodiments, the at least one concave semi-transparent image source has a radius of curvature which is substantially half of the radius of curvature of the concave semi-transparent reflector.

In some embodiments, the adjustment means is arranged for adjusting the at least two image sources individually or in combination.

In some embodiments, the at least two image sources has substantially the same focal point.

In some embodiments, the exhibition system comprises one not-concave image source and one concave semi-transparent image source.

In some embodiments, the at least one concave image source is a flexible OLED display.

In some embodiments, the exhibition system is not a head mounting display.

In some embodiments the concave semi-transparent reflector is constructed by assembling a plurality of smaller-size concave semi-transparent reflectors.

According to an aspect, a method for using the exhibition system according to the above is disclosed, wherein at least one image displayed by an image source is projected onto a concave semi-transparent reflector thereby providing a magnified representation of the image, i.e. a virtual image, appearing in the distance beyond the semi-transparent reflector, and wherein the degree of magnification and/or focus point is adjusted by adjusting the distance and/or angle between the concave semi-transparent reflector and the image source.

In some embodiments according to the above aspect, the method further comprises adjusting the transparency of the concave semi-transparent reflector from completely opaque to between about 30 and 50% transparency.

According to an aspect, a movie display for presenting a mixed reality is disclosed, said display comprises the exhibition system.

According to an aspect, an exhibition display for presenting a mixed reality is disclosed, said display comprises the exhibition system.

According to an aspect, use of the exhibition system for superimposing magnified representations onto the real-world is disclosed.

In some embodiments according to the above aspect, said magnified representation has a size corresponding to the real-size of the object of the image display by the image source and/or a size that will be perceived as natural in relation to the surroundings.

In some embodiments according to the above aspect, the exhibition system is configured to be used in any exhibition context, such as a shop display, such as an advanced learning tool in a museum, such as outdoors, such as showing a new part of a city in development as an overlay on an existing city.

These and further aspects are achieved according to the present invention by providing an exhibition system comprising an image source projecting at least one image onto a concave semi-transparent reflector thereby creating for a user/viewer a perceived magnified representation, i.e. a virtual image, of the at least one image behind said semi-transparent reflector, and wherein said system comprises adjustment means for adjusting the distance between the concave semi-transparent reflector and the first image source and/or for adjusting the angle between the concave semi-transparent reflector and the first image source.

The exhibition system is configured to attach, hold, accommodate, fasten or secure an image source. Alternatively the system comprises an image source. As the exhibition system is configured to attach, hold, accommodate, fasten or secure an image source, the image source may not be a fixed part of the system. The image source may be releasably secured to the system, thus the image source may be attached to the system and detached from the system. The image source may be replaced with a different image source. The image source may be retro-fitted to the system. The system may comprise holding means for releasably securing the image source to the system.

The image source is arranged for projecting at least one image onto a concave semi-transparent reflector thereby providing a magnified representation, i.e. a virtual image, appearing in the distance beyond the semi-transparent reflector. Thus projecting the image onto the reflector provides for a user/viewer a perceived magnified representation of the image behind said semi-transparent reflector.

The image source may an OLED (organic light-emitting diode) display, or a LED (light-emitting diode) display and/or the like.

The display is configured to display an image. This image displayed by the display is configured to be projected onto the reflector.

The image source may be an electronic device comprising a display.

The electronic device may be a mobile device, such as a smart phone, a tablet etc.

The image source is configured to project light rays onto the concave semi-transparent reflector and the light rays will be reflected by the concave semi-transparent reflector. Because of the concave shape of the reflector, the light rays will be reflected towards the same point. A real image is formed if the light rays fully converge in a given point, whereas a virtual image may be formed if the light rays do not fully converge at a given point. A real image forms a visible projection on a screen if the given screen is placed at the point of convergence. A virtual image may not form a visible projection on a screen, but the virtual image can be seen/imaged by the human eye, a camera or other optical instruments. Thus, the image projected from the image source onto the semi-transparent reflector will provide a virtual image and the virtual image will—when viewed by a user through the concave semi-transparent reflector—appear to be magnified, preferably to an extend where the magnified representation, i.e. the virtual image, has a size corresponding to the real-size of the object of the image. This ensures that large objects such as trucks, planes and trains, can be viewed in real-size, i.e. 1:1, even though the image displayed is very small, thereby providing a more real augmented reality. This is e.g. relevant at trade exhibitions, where it will be possible to create a real-size virtual representation of an object without said object having to be physically present at the exhibition. This will not only reduce requirements for storage and transport of the physical objects, but also the requirements to available exhibition space.

In a similar manner it will be possible to superimpose magnified representations, i.e. virtual images, onto a real landscape, allowing the viewer to visualise e.g. new buildings in a city.

Alternatively, virtual images of smaller objects can be magnified in order to provide a better visual inspection of said objects, which is highly relevant in situations where the details of the object is of especially interest, e.g. in relation to small museum artefacts.

Adjusting the size of the magnified representation, i.e. virtual image, can easily be achieved using the system according to invention as the adjustment means ensures that the distance and/or angle between the semi-transparent reflector and the image source can be adjusted e.g. in dependence on which part of the real-world (surroundings) the digital image are to be superimposed upon, thereby ensuring that the virtual representation can have a size that naturally will fall into the surroundings on which said magnified virtual representation is superimposed.

The terms “augmented reality” and “mixed reality” is used interchangeable in the present application and refers to the concept that the real-world or surrounding environment is augmented/enhanced by combining it with virtual images.

It is preferred that the magnified representation, i.e. the virtual image, that by the user is perceived to appear at a distance behind said semi-transparent reflector is magnified at least 1.5 times the size of the image displayed by the image source. It is even more preferred that the virtual image is magnified at least 8 times, e.g. at least 100 times, and even more preferably at least 2000 times the size of the image displayed by the image source. In some situations it may be preferred that the magnification degree is even higher. However, the relevant magnification degree will e.g. depend on the size of image, and the object said image represents as well as the proximity to said surroundings. It is for instance preferred that a magnified virtual representation of a car that has to be shown as parked in front of a real house, has a size in which said car seems to have the correct ratio to said house. Thus, the magnified virtual representation of said car must neither be too small nor to large, as this will disrupt the perception of the augmented reality. In this respect, the adjustment means of the exhibition system will ensure that the magnification degree can be changed according to the users wishes.

The exhibition system according to the invention presents, for a user/viewer, a perceived magnified virtual representation at a distance behind/beyond the concave semi-transparent reflector and said magnified virtual representation will preferably be perceived as a quasi-3D virtual image, thereby significantly adding to the sense that the image is physical connected with the real-world/surroundings.

An image projected onto the concave semi-transparent reflector from an image source that is located between the focal point and the reflective concave surface will appear to be magnified, and will provide a “magnified representation” of said image, i.e. a magnified virtual image, that appears to be “virtually” further away to the eye both in terms of focus and location than the image is physically. Thus, the magnified virtual image will—from a user's perspective and when viewed through the concave semi-transparent reflector—appear to be present behind the semi-transparent reflector, such as appear to be located beyond the semi-transparent reflector. Thus, the virtual image will give the user the perception that the motive/character/object from the image is positioned e.g. across the room or far away in the sky.

The apparent focus point of the magnified virtual representation will vary as a function of the focal length of the concave semi-transparent reflector, the distance of the image source from said reflector, and/or the angle between the concave semitransparent reflector and image source. Thus since the exhibition system according to the invention comprises adjustment means arranged for adjusting at least one of the distance between the image source and the concave semitransparent reflector, the angle of said reflector in relation to the base, and the angle of the image source in relation to the base, it will be possible to obtain the desired perspective and/or desired degree of magnification. In the context of the present invention the term base, means the surface on which the exhibition system according to the invention is placed and/or mounted upon, and can be the ground, the floor, etc.

Generally, as the image source approaches the focal length of the concave semi-transparent reflector, the magnification increases and the virtual image will from a user's perspective appear to be further behind the semi-transparent reflector both in location and focus. It is preferred that the magnified representation i.e. the virtual image, should appear in the distance (e.g. at “infinity” in the optical sense) beyond the semi-transparent reflector, as this will create a very special and effectual combination of a digital image superimposed on the real world.

As an example can be mentioned, that if the digital images projected onto the concave semi-transparent reflector are flying space ships, the system according to the invention will provide the viewer with the perception that said space ships are flying over the viewer's actual physical location simply because the viewer can see the real surroundings through the concave semi-transparent reflector. Since said space ships preferably are perceived as flying in the skies, i.e. at “infinity” in the optical sense, it is preferred that the distance between the image source and the concave semitransparent reflector is near or at the focal length of the reflector. However, if the digital images instead were cars, it could be advantageously that the magnified virtual representations were presented to appear closer to the user, i.e. not at infinity, and in such situation the distance between the image source and the reflector should be smaller than the focal length of the concave semi-transparent reflector.

Thus, using the exhibition system according to the invention provides the possibility of adjusting the magnification and position of the magnified virtual representation, thereby blending real and virtual elements into seamless composite scenes. By combining the real world with magnified virtual images e.g. from video processing and computer vision techniques, the system offer a natural view of real scenes enriched with “real size” virtual objects.

The magnified virtual representation that is viewable by a user through the concave semi-transparent reflector, will have an effective magnification range that can be changed without changing the apparent field of view or resolution. The distance between the image source and concave semi-transparent reflector may be changed by moving the image source, and/or the concave semitransparent reflector, backwards and forwards, thus giving the effect of changing the magnification of the magnified virtual representation observed by the user without changing the apparent field of view or resolution. Furthermore, in order to ensure that the nominal user is able to view the complete magnified virtual representation, the angle between the reflector and the image source may be altered, e.g. by adjusting the angle of either the reflector and/or the image source in relation to the base of the system.

Thus, the possibly of adjusting the distance and/or angle between the reflector and the image source, not only has the advantage that the magnified virtual representation of the digital image may be altered but also that the user easily can achieve a comfortable viewing position.

It is further preferred that the exhibition system according to the invention comprises one or more predetermined fix-points, in which the concave semi-transparent reflector and/or the image source can be locked and wherein each fix-point provides a predetermined indication of the magnification degree of the virtual representation of the digital image and how far beyond the semi-transparent reflector the magnified virtual representation appears in the distance.

The image source and/or the concave semi-transparent reflector are preferably placed in an exhibition display, which may also comprise the adjustment means for adjusting the position i.e. the specific distance and/or angle between the image source and the concave semi-transparent reflector in said exhibition display.

The adjustment means can in one embodiment be a simply mechanic device arranged such that either the angle or the placement of one or both of the reflector and/or the image source can be manually adjusted.

In one preferred embodiment, the concave semi-transparent reflector is placed at a fixed location, and the at least one image source can be manually moved back and forth using the adjustment means. In such an embodiment the adjustment means may comprise a connecter, to which the image source is attached, a longitudinal track in which the position of the connecter can be adjusted by slinging it back and forth along said track, and a fastening means for securing the connecter at different e.g. predetermined positions along the track. Said fastening means can be a simple nut and/or screw, but can in principal be any means that will ensure that the connecter, and accordingly the image source, can be either displaced or maintained at a desired position. It will be understood that other arrangements also are contemplated within the scope of the invention, e.g. that the image source is placed in a fixed position and the concave semi-transparent reflector are moved back and forth, or that both the image source and concave semitransparent reflector can be moved back and forth along each their track. The angle of the concave semi-transparent reflector and/or the image source can e.g. be adjusted using a hinge or similar arrangement.

It is preferred that said adjustment means is arranged for automatically changing and/or adjusting one or more of the desired parameters, e.g. the distance between the reflector and the image source, based on e.g. which images is projected by the image source. In one embodiment the position of the image source is adjusted by monitoring the position of a concave semi-transparent reflector and adjusting the position of the image source based on the monitored position of said reflector, e.g. using input from respective sensors and relevant computation means. In a different embodiment a user can add information as to the size of the desired magnified virtual representation of the image projected onto the concave semitransparent reflector, and the image source and reflectors position can be adjusted accordingly.

The means for the automatic adjustment of the position can e.g. be robotics or similar means arranged for adjusting the relevant position of the image source and/or concave semitransparent reflector.

Since it is possible to adjust the respective position of the elements of the system (image source and concave semitransparent reflector), the present invention allows e.g. the user to adjust the focus position of the magnified virtual representation of the image produced by the image source, yet maintain the resolution of the image. In other words, if the user wants to move the magnified virtual representation further away, the adjustment means ensures that the distance between the concave semi-transparent reflector and the image source can be adjusted, either automatically or manually. Similar the relevant position of the magnified virtual representation can be altered/corrected by changing the angle of one or both of the concave semi-transparent reflector and the image source in relation to the base, thereby altering the mutual angle between the concave semi-transparent reflector and the image source. This may also provide a more comfortable viewing focus for the user. This can, as mentioned above, e.g. be achieved by using a hinge arrangement attached to the concave semi-transparent reflector and/or the image source.

In use the magnified virtual representation provided by the exhibition system according to the invention, will together with the real world create a reality (augmented reality) of a definition and a scale never seen before and will result in a much more realistic look than anything previously achieved using conventional augmented/mixed reality technology. Such an enhanced “illusion” broadens the possibilities of use, both as the system according to the invention can be used under a wider spectrum of conditions and due to the fact that it is possible to display more challenging images, than possible using e.g. the head mounted displays know in the art. Accordingly, the system according to the invention can be used in many exhibition contexts, from a shop display to advanced learning tools in a museum, as well as outdoors, showing a new part of a city in development as an overlay on the existing city.

As the images displayed by the image source can be magnified up to more than 2000 times using the system according to the invention, the present invention provides an exhibition system arranged for providing a large magnified virtual representation of the image without a large image source, i.e. the exhibition system will be physically small compared to the magnified virtual representation. The relative cost of the system is therefore less expensive compared to large screen monitors, and said systems will require less space both for displaying the objects of interest, and for storing the exhibition system. By including at least one adjustment means, the exhibition system according to the invention is not only capable of providing different degrees of magnification, but also that an augmented/mixed reality is provided, which conventional large screen displays cannot provide.

The magnified virtual representation of the image can in one embodiment be presented as appearing on a screen, but it is preferably that the magnified virtual representation is superimposed on the real world, i.e. appearing behind the screen, thereby creating an effectual large scale augmented reality/mixed reality that can be perceived by a viewer looking though the concave semi-transparent reflector.

Museums, manufactures, sellers and other similar groups are keen on presenting their collections in a more appealing and exciting manner to attract visitors and/or buyers, and the system according to the invention provides an efficient way of creating models of trade goods/artefacts and/or building virtual exhibitions. As the magnified virtual representation will change in dependence of the images projected onto the concave semi-transparent reflector, it will be possible to view an object (as a virtual representation of the image) from different sides, or many different objects over time, thereby again reducing costs and requirements for exhibition and storage space.

In a preferred embodiment the concave semi-transparent reflector and image source are placed at a mutual angle such that a viewer can stand behind the image source and look through the concave semi-transparent reflector without the image source disrupts the view. It is accordingly preferred that the concave semi-transparent reflector is placed at an angle between 5 and 25 degrees in relation to the base on which the system according to the invention is placed. In a preferred embodiment the concave semi-transparent reflector is placed at an angle between 10 and 20 degrees, most preferably about 15 degrees, in relation to said base. The image source is preferably angled in relation to the concave semi-transparent reflector, such that the image displayed by said image source is projected at a preferred angle onto the reflector, i.e. directly into the focus point of the reflector. The angle of the image source in relation to the base, will in this respect depend in the distance between the concave semi-transparent reflector and the image source.

A reflective substantially spherical surface of radius “R” will have a focal length of R/2. For purposes of this application, the radius of the concave semi-transparent reflector will be defined as the general curvature of the inner surface of said reflector, i.e. the side of the concave semi-transparent reflector that is facing the image source.

The inventors of the present invention has found that in a first embodiment it is preferred to use a concave semitransparent reflector having a size in the area between 800×800 mm and 2000×2000 mm, with a radius of curvature between 2200 mm and 5000 mm, preferably about 2800 mm, as this has proven to provide the desired sizes of the magnified representations, without providing a distortion of the image. However, the concave semi-transparent reflector may have other suitable sizes/dimensions depending on the intended use, and it may have a plate like shape which is e.g. substantially rectangular, substantially circular, substantially quadratic etc. In a similar manner the radius of curvature may vary depending on the intended use, dimension, and shape.

As an example can be mentioned, that if the exhibition system is to be used to display objects/items capable of being viewed from different positions, the size/dimension of the concave semi-transparent reflector may be around 12×24 m or even larger, preferably having a radius of curvature of 65000 mm. However, the size/dimension of the concave semi-transparent reflector may also be small in comparison, e.g. around 100×200 mm, having a radius of curvature of 300 mm. Thus, the radius of curvature may vary between 250 mm and 70000 mm, depending on the size of the concave semi-transparent reflector and/or the intended use.

The concave semi-transparent reflector may be constructed by assembling a plurality of smaller-size concave semi-transparent reflectors. For example for providing a large concave semi-transparent reflector having a size of 12×24 m, a number of smaller-size concave semi-transparent reflectors may be assembled, such as mounted together on a metal frame. If concave semi-transparent reflectors having a size of 3000 mm×3000 mm (3×3 m) are used to construct the large concave semi-transparent reflector of size 12×24 m, then these smaller-size concave semi-transparent reflectors may be arranged with four concave semi-transparent reflectors of size 3000×3000 mm in one direction, e.g. y-direction, and eight concave semi-transparent reflectors of size 3000×3000 mm in the other direction, e.g. x-direction.

The other side of the semi-transparent reflector may have a radius of curvature that differs from that of its inner side by about the thickness of the reflector. However, since it has been observed that light which passes through a semi-transparent reflector, that has inner and outer surfaces with similar radii of curvature will be minimally distorted and its magnification minimally affected, it is preferred that the inner and outer surfaces of the concave semi-transparent reflector has a substantial similar radii of curvature.

Because the distance that the reflected virtual image at the semi-transparent reflector, i.e. the virtual image, appears in the distance increases as the distance between image source and the reflector approaches the focal length of the reflector, the distance from reflector to image source should be as large as possible without exceeding the focal length of the reflector. Conversely, if this distance exceeds the focal length of the reflector, the virtual image becomes unstable and out of focus, and it is accordingly desirable that the system is arranged such that the distance between the reflector and/or image source cannot exceed the focal length of the concave semi-transparent reflector.

It is in this respect preferred that the exhibition system comprises a stop means for preventing that the distance between the concave semi-transparent reflector and the image source excess the focal length of the concave semi-transparent reflector. This can in a simple embodiment be obtained by ensuring that the path/track on which the image source and/or concave semi-transparent reflector can be displaced in relation to each other, only has a length which corresponds to the focal length of the reflector, however different means for obtaining the same effect are well known in the art and is accordingly also contemplated within the scope of the present application.

Within the context of the present invention, the term “semi-transparent reflector” means a partially-reflective/partially-transmissive optical surface (a “beam splitter”) where the surface's reflectivity is used to display the magnified representation as a virtual image (in the optical sense) and the surface's transmissivity is used to allow the user to view the real world directly. Thus the term not only covers glass, but also comprises reflective and semi-transparent membranes and foils made of e.g. a polymeric composite. The transparency of the concave semi-transparent reflector is preferably between about 30-50%, as this provides the optimal conditions for the perception of the augmented reality. The choice of the transparency of the semi-transparent reflector depends on the intended application of the system according to the invention.

In order to ensure that the magnified virtual representation of the image is not distorted, it is preferred that the semi-transparent reflector is able to collimating the image that is being reflected.

It is preferred that the reflective layer of the “semitransparent reflector” is the inner side layer facing the image source, as it is then possible to use the system according to the invention to create virtual images of a definition and a scale never before possible resulting in a much more realistic look than anything previously achieved.

Alternatively the semi-transparent reflector can comprise a thin protective layer covering the reflective layer, as this will provide a larger resistance to the reflector. Said protective layer is preferably less than 400 nm, more preferably less than 200 μm, and even more preferably less than 50 μm. In a preferred embodiment the system comprises means for adjusting the transparency of the concave semi-transparent reflector, and wherein the transparency of said reflector can be adjusted from being completely opaque to being about 30-50% transparent.

Glass or glazing, in which it is possible to adjust and/or control the transparency degree are normally referred to as “smart windows”, and is conventionally used to control privacy and sun radiation (i.e. energy) in buildings and vehicles. Examples of such smart windows are disclosed in e.g. U.S. Pat. Nos. 5,486,937; and 6,072,549. Alternatively the smart window can be an electrochromic device, a suspended particle device (SPD), a micro-blind, but in principal any kind of device/window can be used in which the light transmission properties of said device can be altered when voltage, light or heat is applied.

Other means of adjusting the transparency of the concave semi-transparent reflector comprises the use of polarizing filter(s) arranged for being rotated to a rotational angle that control the intensity of the ambient light coming though the concave semi-transparent reflector. One example of such a system is the RoscoVIEW™ system obtainable from Rosco Laboratories, and in which a wide width polarizing filter is installed on the concave semi-transparent reflector and a matching “camera” polarizing filter is placed between the image source and the concave semi-transparent reflector. This ensures that the light emitted though the semi-transparent reflector easily can be controlled by rotating the camera filter, since the camera filter changes the degree of cross polarization on the reflector where the polarizing filter is installed. This results in 100% control of exterior brightness as seen through the concave semi-transparent reflector. The camera filter can either be arranged to be rotated manually, or it can be arranged to be rotated automatically e.g. based on data from sensors that measures the intensity of the incoming light. For the sake of simplicity, the RoscoVIEW™ system is referred to as a “smart window” in the present application.

In one embodiment the concave semi-transparent reflector is constructed as a smart window, however in a different embodiment the exhibition system comprises a smart window positioned behind the concave semi-transparent reflector seen in a position of use, i.e. the smart window is not placed between the image source and the concave semi-transparent reflector. Using a smart window provides a number of benefits, as the smart window structure will have light transmission characteristics that can be electrically controlled for a specific time period in order to adjust the degree of transparency.

For instance, having a system in which the transparency of the smart window, e.g. in the form of the concave semi-transparent reflector, can be adjusted ensures that the exhibition system according to the invention will be configured with means for providing an enhanced mixed reality or augmented reality. When the smart window is completely opaque (i.e., with no transparency) the smart window will simply functions as a screen on which the projected image appears to be displayed. When the transparency is e.g. between 30 and 50% a clear image of the background is provided, allowing the viewer both to see the real world and a magnified virtual representation through said reflector or smart window.

Since the transparency of the smart window can be regulated, it will be possible to open and/or close the view though said window (or the concave semi-transparent reflector when said reflector functions as a smart window) either completely or to a desired degree, and accordingly determine if the background is to be displayed or not. This will create an effectual way of incorporating a viewer's real background into a movie. For instance, if the image projected onto the concave semi-transparent reflector is flying space ships, the system according to the invention will—when the smart window allows the viewer to see thought it—provide the viewer with an perception that said space ship is flying over the viewer's actual physical location simply because the viewer can see the real surroundings behind the reflector. In a similar manner the background can be completely blocked out in situations where the background is not relevant or will distort the experience, in which cases the smart window e.g. the concave semi-transparent reflector, will function as a normal screen.

The transparency of the smart window can be controlled in a number of different conventional ways, but in a preferred embodiment the exhibition system comprises computing means for in dependence of relevant data, e.g. a time code, a sound output or similar data, controls when the displayed images are to be displayed on an opaque smart window blocking the surroundings out, and when the displayed images are to be superimposed on the real-world. Accordingly, an instructor will be able to incorporate visual effects into a movie of a format never seen before, as the real-world of the surroundings effectively can become part of the movie, e.g. when a landscape is presented in the move, and later blocked out e.g. in close up scenarios.

The image source can in principal be any kind of image source capable of projecting an image onto the concave semitransparent reflector. It is however preferred that the image source is a retail display device which not only will provide an inexpensive exhibition system, but also ensures that the maintenance of the system is almost completely eliminated. As one example, the image source can be a conventional display e.g. an LCD, as this will provide a screen of good quality as well as being reasonable in price. An advantageous other option is to use an OLED display which has self-luminous characteristics due to the improved contrast, but in principle any screen is applicable.

In some situations the magnified virtual representation of an object will have a tendency of being perceived as “bend” when viewed through the concave semi-transparent reflector, especially when said image is originating from a “flat” image source. This is basically due to the fact that the distance from the “flat” image source to the concave semi-transparent reflector is not uniform over the entire projected image.

It may in this respect be preferred to use a concave image source, such as a flexible OLED display, providing the possibility of both magnifying a displayed image and at the same time change focus positions, and accordingly the light coming from the display, thereby ensuring that the virtual image will not be perceived as a “bend” magnified virtual representation.

In a preferred embodiment of the exhibition system according to the invention, the system comprises at least two image sources, and wherein at least one of these image sources is a concave semi-transparent image source.

Since each of the respective image sources will project images onto the concave semi-transparent reflector creating individual magnified virtual representations, not only will the viewer obtain a better perception of depth, but the image being projected from the concave semi-transparent image source will be “corrected” such that the virtual image will be perceived as correct, i.e. without any bending/distortion.

Using at least two image sources, further has the advantage that it is possible to provide several magnified virtual representations with different magnifications, thereby providing an even better and more realistic augmented reality.

In order to ensure that all images can be projected onto the concave semi-transparent reflector, the system is preferably arranged such that the images from the respective image source is projected through the concave semi-transparent image source, i.e. the concave semi-transparent image source is preferably placed closest to the concave semi-transparent reflector.

Even though the at least two image sources can project images at different sections of the concave semi-transparent reflector, it is preferred that the at least two image sources has substantially the same focal point i.e. that the two image sources are optically concentric, whereby the images will be perceived as layered magnified virtual representations.

The at least one concave semi-transparent image source can have a radius of curvature corresponding substantially to the radius of curvature of the concave semi-transparent reflector, i.e. the distance between the concave image source and the concave reflector is uniform over the entire system. It is however preferred that the at least one concave semi-transparent image source has a radius of curvature which is smaller than the radius of curvature of the concave semi-transparent reflector as it is thereby ensured that the magnified virtual representations will be perceived without bending.

The inventors of the present invention has in this respect found that using a concave semi-transparent image source having a radius of curvature that is substantially half of the radius of curvature of the concave semi-transparent reflector an especially advantageous effect is provided in which the virtual image is perceived without any substantial bending. In one example of such an embodiment the radius of curvature of the concave semi-transparent reflector is 2800 mm and the concave semitransparent image source has a radius of curvature about 1600 mm.

Other radius of curvature of the concave semi-transparent image source are also contemplated within the scope of the present invention, such as a third or a quarter of the radius of curvature of said semi-transparent reflector.

It is further preferred that the adjustment means is arranged for adjusting the at least two image sources individually. In this way it will be possible to adjusting the size of the at least two magnified virtual representations individually, as the adjustment means ensures that the distance and/or angle between the semi-transparent reflector and the image sources can be adjusted e.g. in dependence on which part of the real-world (surroundings) the digital images are to be superimposed upon. Thus, it can be ensured that each magnified virtual representation will have a size that naturally falls into the surroundings on which said magnified virtual representation is superimposed.

In a simple embodiment the adjustment means is arranged for adjusting the at least two image sources in combination, i.e. when the distance and/or angle between the semi-transparent reflector and one of the image sources is the adjusted, the distance and/or angle between the at least other image source is also adjusted.

In an especially simple embodiment the system acceding to the invention comprises two image sources, one flat (not-concave) image source and one concave semi-transparent image source, and wherein the two image source are an integrated unit, i.e. they are abutting, or almost, abutting each other. The at least one concave semi-transparent image source may be any kind of image source meeting the requirements according to the present invention, it is however preferred that said concave semi-transparent image source is a flexible OLED display, having a transparency of at least 50%.

In one embodiment according to the invention, the exhibition system comprises a mirror, and in a position of use the system is arranged such that the image source is placed below the concave semi-transparent reflector and the mirror is placed in front of said reflector, and wherein the mirror, the at least one image source and the concave semi-transparent reflector is arranged and positioned such that the image from the image source will be reflected in the mirror and then projected onto the concave semi-transparent reflector, thereby creating a magnified virtual representation of the at least one image that to the user is perceived to appear behind said semi-transparent reflector.

The advantage of such a system is that the image displayed by the image source will not be reversed/mirrored when viewed though the concave semi-transparent reflector, an apparent benefit if the image e.g. comprises text.

A further advantage is that the distance between the mirror and the concave semi-transparent reflector can be reduced, compared to the distance of an image source placed in front of the reflector. The adjustment means will still be arranged for adjusting the distance between the concave semi-transparent reflector and the first image source and/or for adjusting the angle between the concave semi-transparent reflector and the first image source, e.g. in order to ensure that the image from the image source is reflected at the right angle in the mirror in order to create the magnified virtual representation that is perceived by the user/viewer to be located behind/beyond the reflector.

In order to ensure that the magnified virtual representation can be viewed properly, it is important that the image source displays the images with sufficient light so that the viewer is able to clearly perceive the image independently on the amount of light in the surroundings. It is accordingly preferred that the exhibition system comprises means for controlling the brightness i.e. the amount of light of the image projected onto the at least one concave semi-transparent reflector. It is further preferred that said brightness is based on ambient light conditions. Such brightness controlling systems are already known from e.g. mobile phones and a person skilled in the art will be able to implement a similar technology into the system according to the invention, based on the teaching of the present invention.

As one example of an advantageously image source can be mentioned that Dynascan™ produces a High Brightness LCD with a maximum brightness ratings up to 7,000 cd/m2 ensuring that all images projected onto the concave semi-transparent reflector can be viewed independently of the ambient light conditions, i.e. the magnified virtual representation can be viewed even in direct sunlight. Said display also comprises a brightness controlling system as described above.

The images projected from the image source may be still or moving images, however in a preferred embodiment the images are digital images e.g. moving pictures which presents free floating video elements, which is combined with the background in order to provide the mixed/augmented reality. The magnified virtual representations of digital images can e.g. be used to show a physical object from different sides. This is a smart and effective way of e.g. illustrating the use of an object e.g. a car or the changes over time of the surface of the earth or the earth's atmosphere.

It is preferred that the images projected from the monitors are isolated by their outline, whereby the quasi-3D perception of said images will be further enhanced. This technology is well known in the art, but as an example can be mentioned that the images can be isolated using a cut-out technology or be recorded against a single-coloured background. In postproduction, the background can be removed, for instance by computer processing, and be replaced with black. On the monitor device, the background will be black and only the image can be seen, thereby significantly adding to the sense that the image is physical connected with the real surroundings, since no interference is displayed.

The present invention also relates to a method of using the exhibition system according to the invention. In said method an image from an image source is projected onto a concave-transparent reflector thereby creating a magnified virtual representation of the image that to the user is perceived to be located behind said semi-transparent reflector. As already discussed earlier in the application it will be possible to adjust the degree of magnification of said virtual image and/or the viewers focus point by adjusting the distance and/or angle between the concave semi-transparent reflector and the image source, thereby ensuring that the viewer is always provided with the best and most real visual experience.

In a preferred embodiment the transparency of the concave semi-transparent reflector is adjusted from completely opaque to about 50% transparent, preferably between 30-45% transparency thereby ensuring that it can be regulated when, and/or to which extend, the viewer will be able to observe the surroundings through the concave semi-transparent reflector. This will provide a number of possibilities in e.g. the movie or advertising industry as the viewer will be provided with experience of being part of the movie, as the actual surroundings/background becomes part of the viewed augmented reality.

The invention will be explained in greater detail below, describing only exemplary embodiments of the display with reference to the drawing, in which

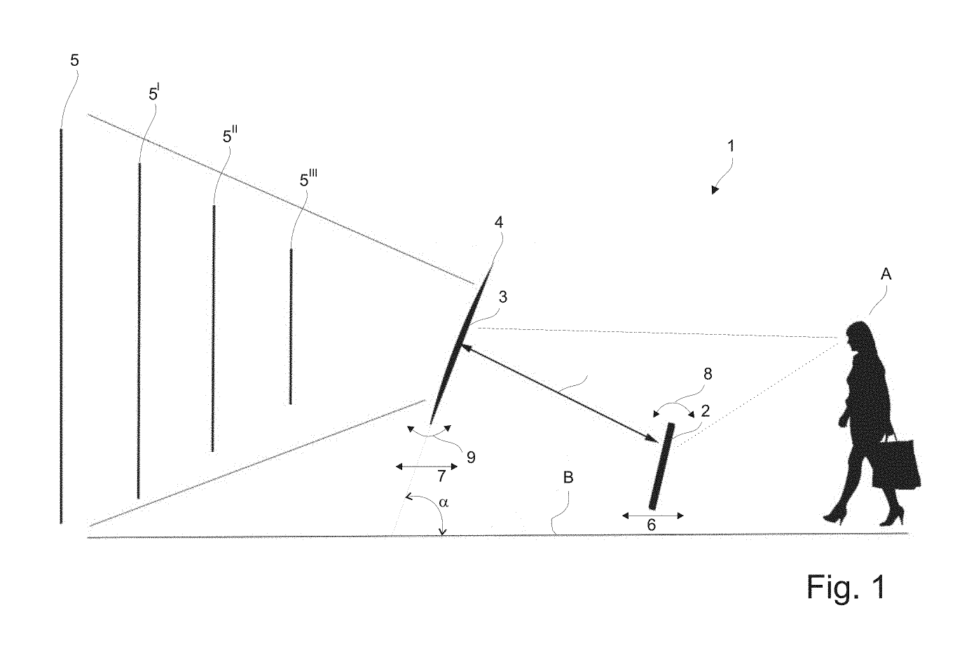

FIG. 1 is a schematic view of an exhibition system according to the invention,

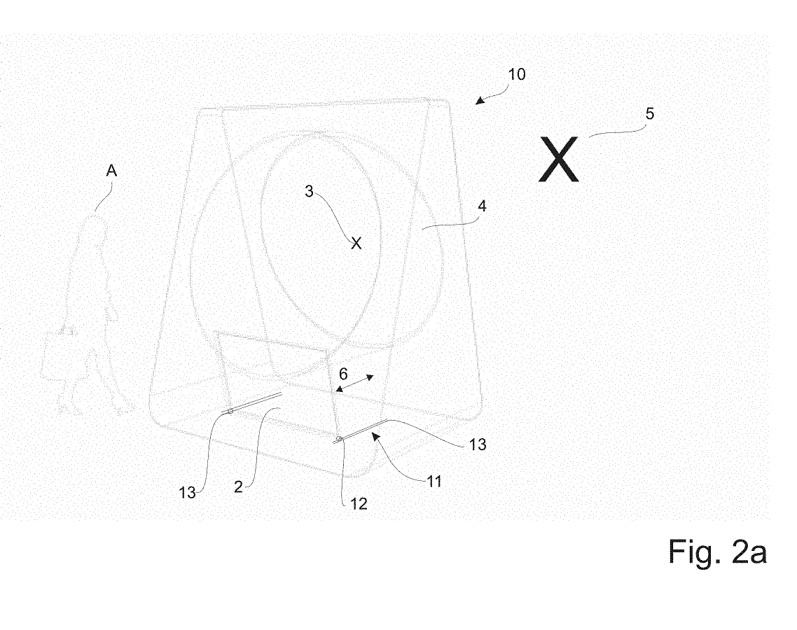

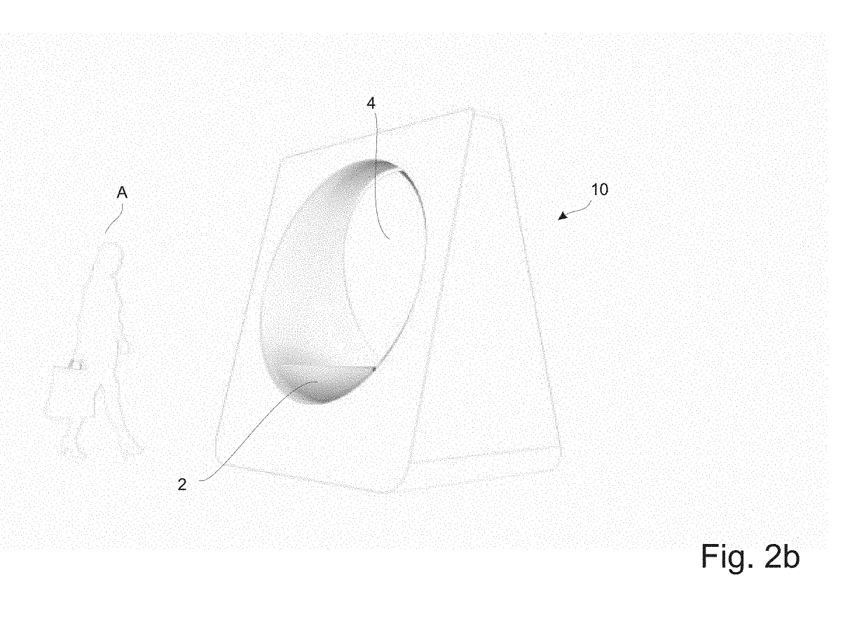

FIG. 2a shows a first embodiment of an exhibition display incorporating the exhibition system according to the invention,

FIG. 2b shows the embodiment of FIG. 2 in a position of use,

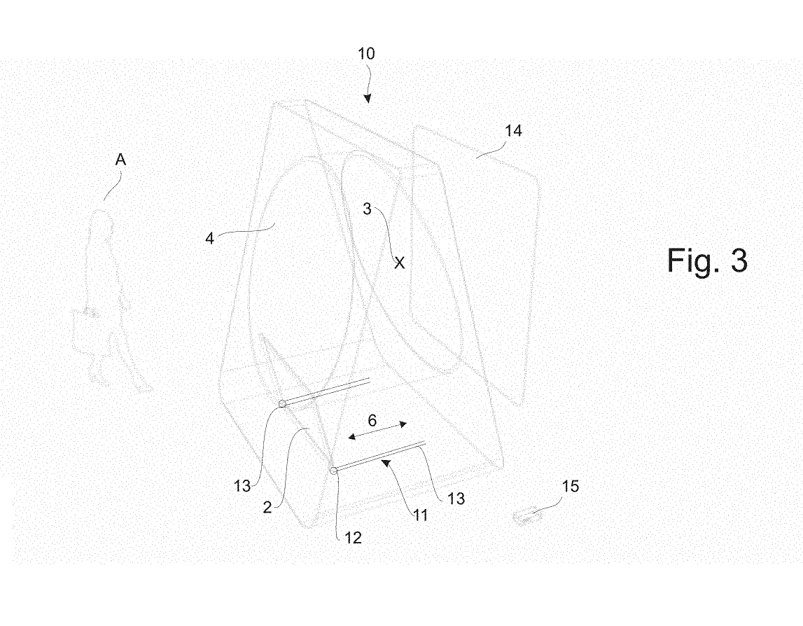

FIG. 3 shows a second embodiment of an exhibition display incorporating the exhibition system according to the invention, and

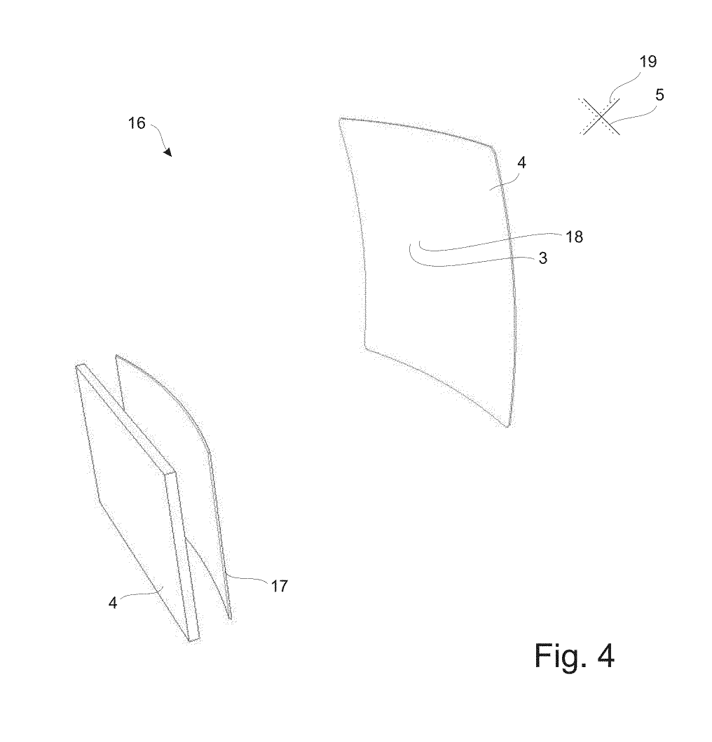

FIG. 4 is a schematic view of second embodiment of an exhibition system according to the invention.

FIG. 1 shows a schematic representation of an exhibition system 1 in accordance with the principles of the present invention. The exhibition system comprises an image source 2 projecting at least one image 3 onto at least one concave semi-transparent reflector 4 thereby creating a magnified virtual representation 5 of the image that by a user is perceived to be located behind said semi-transparent reflector. Thus, it appears to the user that the motive/character/object of the image is in a location beyond the semi-transparent reflector, while in reality the user is seeing a virtual image of the motive/character/object.

The image 3 projected from the image source onto the semi-transparent reflector will—when viewed by a user A through the concave semi-transparent reflector 4—appear to be magnified, preferably to an extend where the magnified virtual representation 5 has a size of between 1.5 and 2000 times the image 3 display by the image source 2. This ensures that large objects such as trucks, planes and trains, can be viewed as objects in real-size, but also that small items can be magnified in order to provide better and more impressive virtual representations.

The magnified virtual representation 5 that is viewable by a user through the concave semi-transparent reflector 4, will have an effective magnification range that can be changed without changing the apparent field of view or resolution. By moving e.g. the image source backwards or forwards, represented by arrow 6, the virtual magnification 5, 5′,5″, 5′″ of the projected image 3 can be altered without changing the apparent field of view or resolution of the image 3. A similar effect is possible by moving the concave semi-transparent reflector 4 backwards or forwards, as represented by arrow 7.

Furthermore, in order to ensure that the nominal user eye position is able to view the complete magnified virtual representation, e.g. if the distance between the reflector and image source is altered, it might be desirable to change the mutual angle between the reflector and the image source, e.g. by adjusting the angle of either the image source represented by arrow 8 and/or by adjusting the angle of the concave semi-transparent reflector, illustrated by the arrow 9, in relation to the base B, on which the system is placed. Thus, different parameters of the concave semi-transparent reflector and the image source can be altered and/or adjusting, both ensuring that the desired degree of magnification can be provided, and that the user easily can obtain a comfortable view.

If the image source 2 is movable along the optical line of sight of the user A, as is indicated by the arrow 6. The user views a magnified virtual representation 5 of an image 3 displayed by the image source 2 through the reflector 4.

More specifically, the image source 2 will be placed at the proper distance from the reflector 4 to produce a virtual magnified image 5, the placement of which will depend on the distance X between the concave semi-transparent reflector 4 and the image source 2.

Generally, as the distance between the reflector and the image source approaches the focal length of the concave semitransparent reflector 4 the magnification increases and the virtual image of the object appears to be further behind the semi-transparent reflector 4 both in location and focus. It is preferred that the magnified representation (virtual image) should appear in the distance (e.g. at “infinity” in the optical sense) beyond the concave semi-transparent reflector 4, as this will create a very special and effectual combination when a large scale image is superimposed on the real world.

Thus, if the distance X is near the focal length of the concave semi-transparent reflector 4 the magnified virtual representation will be perceived at infinity, illustrated by the magnified virtual representation 5, whereas said magnified virtual representation will be perceived as closer to the viewer if the distance is less than the focal length. Different distances of X is represented by the magnified representation 5′, 5″ and 5′″ in FIG. 1.

As is evident from FIG. 1 the concave semi-transparent reflector 4 and the image source 2 are placed at a mutual angle such that user can stand behind the image source 2 and look through the concave semi-transparent reflector without the image source disrupting the view. It is accordingly preferred that the concave semi-transparent reflector is placed at an angle □ between 5 and 25 degrees in relation to the base B the system is mounted upon. The image source 2 is also angled in relation to the concave semi-transparent reflector 4, such that the image displayed by said image source is projected at the right angle onto the reflector, i.e. directly into the focus point of the reflector. The angle will in this respect depend in the distance X between the concave semi-transparent reflector 4 and the image source 3, and the angle of the reflector 4.

In one implementation, for example, the reflector has a diameter of 1500 mm and a radius of curvature in the order of about 2800 mm for the inner surface. This results in a focal length of about 1400 mm for the concave semi-transparent reflector 4. In this embodiment the distance X between concave semi-transparent reflector 4 and image source 2 was placed just before the focal length, e.g. at 1370 mm, to provide a 30 mm margin to avoid the potential of an instable system, especially considering the possibilities for adjusting the image source and concave semi-transparent reflector as described earlier.

In that arrangement, with the distance between the reflector and the image source being almost about ½ the radius of curvature of reflector, the viewer A is provided with a view through the reflector 4 in combination with a magnified virtual reflected image 5 that appears to be at an infinite distance beyond the concave semi-transparent reflector.

In FIGS. 2a and 2b the image source 2 and the concave semi-transparent reflector 4 has been combined in an exhibition display 10, providing a convenient and appealing exhibition system 1 according to the invention. The exhibition display 10 is in FIG. 2a showing the main components of the system and in FIG. 2b the exhibition display is shown as it would appear to a viewer.

In order to ensure that the magnified virtual representation 5, that is viewable by a user through the concave semi-transparent reflector 4, will have the desired size (magnification degree), the image source 2 is connected to an adjustment means 11, that allows the distance between the image source 2 and the concave semi-transparent reflector 4 to be changed. In the embodiment shown the position of the concave semi-transparent reflector 4 is fixed, but the distance X between said reflector and image source is changed by moving the image source 2 backwards or forwards, represented by arrow 6. The magnification 4 of the projected image 3 can then be altered without changing the apparent field of view or resolution of the image 3.

The adjustment means 11 comprises connecters 12, to which the image sources 2 is attached, and a two tracks 13 in which the position of the connecter 12 can be adjusted by sliding it back and forth along said tracks 13, e.g. using a handle (not shown) that is attached to said connectors 12, and which extends out of the exhibition display 10 for easy manipulation. The adjustment means 11 further comprises a fastening means (not shown) for securing the connecters 12 at different e.g. predetermined positions along the tracks 13. Said fastening means can in principal be any means that will ensure that the connecters 12, and accordingly the image source 2, can be either displaced or maintain at a desired position.

FIG. 3 basically shows the same embodiment as in FIG. 2 but with the addition that a smart window 14 has been placed behind the concave semi-transparent reflector 4, seen in the viewing position. Using a smart window 14 will provide an enhanced augmented reality. When the smart window 14 is completely opaque (i.e., with no transparency) the smart window will simply functions as a screen on which the projected image 3 is displayed. However, when the transparency of said smart window 14 is e.g. between 30 and 50% a clear image of the background is provided, allowing the viewer both to see the real world and the magnified virtual representation 5. Accordingly, an instructor will be able to incorporate visual effects into a movie of a format never seen before, as the real-world of the surroundings effectively can be an integrated part of the movie, e.g. when a landscape is presented, and later blocked out e.g. in close-up scenarios etc. It will be understood that in a further embodiment, the concave semi-transparent reflector 4 is the smart window, i.e. the transparency of said reflector 4 is controlled.

The transparency of the smart window 14 is controlled by computing means 15 which communicates with the smart window in a conventional wireless way.

In the embodiment shown, the concave semi-transparent reflector 4 is preferably curved to be a “substantially spherical” surface, meaning that its surface is not perfectly spherical but is sufficiently close to being spherical so as to behave similarly to a perfectly spherical surface within the context of these embodiments.

It has however been discovered, that providing a slightly aspherical but still substantially spherical inner surface of the reflector 4 can help to correct for keystone and barrel distortion in the image as reflected to it from the image source 2.

FIG. 4 shows a schematic view of second embodiment of an exhibition system according to the invention. Said embodiment corresponds in principal to the embodiment shown in FIG. 1, with the modification that it comprises two image sources, one flat (not-concave) image source 2 and one concave semitransparent image source 17.

The concave semi-transparent image source 17 has a radius of curvature corresponding substantially to the radius of curvature of the concave semi-transparent reflector 4, i.e. the distance between the concave image source 17 and the concave reflector 4 is uniform over the entire system, whereby it is ensured that the magnified virtual representations will be perceived without bending.

Each image source, 2, 17, will projecting at least one image 3,18 onto the concave semi-transparent reflector 4 thereby creating at least two magnified virtual representation 5,19 of the images behind said semi-transparent reflector 4. Not only will this provide a better perception of depth for the viewer, but the image 18 being projected from the concave semi-transparent image source will be “corrected” such that the image will be perceived as correct, i.e. not bend. For instance if the object to be perceived is a bus, the magnified virtual representation of said bus 19 is “straight”.

The two image source 1, 17 have substantially the same focal point i.e. that the two image sources are optically concentric, whereby the images will be perceived as a layered magnified virtual representation 5,19.

The two image source 4,17 are arranged as an integrated unit, i.e. they placed very close to each other, such that the adjustment means can adjust the two image sources in combination.

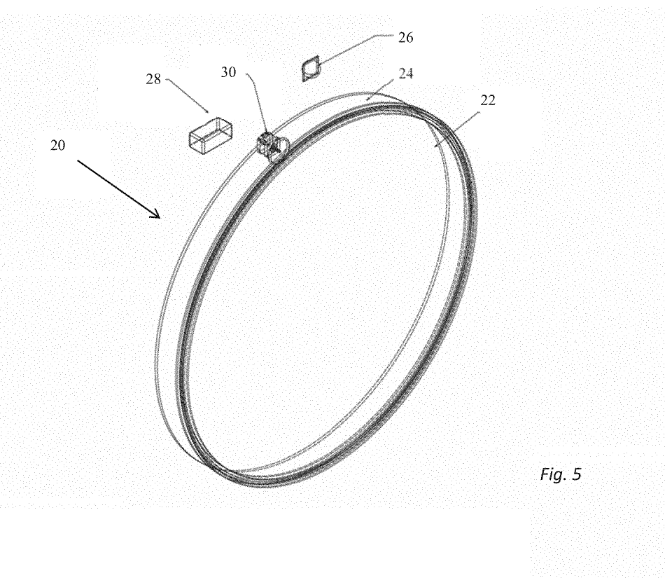

FIG. 5 shows an example of a polarizing filter. The polarizing filter 20 may be the means for adjusting the transparency of the concave semi-transparent reflector arranged for being rotated to a rotational angle that control the intensity of the light coming though the concave semi-transparent reflector. The polarizing filter 20 may be a circular polarizer. The polarizing filter 20 may comprise a first polarizer 22 and a second polarizer 24. The first polarizer 22 may be a wide width polarizing filter installed on the concave semi-transparent reflector. The second polarizer 24 may be a matching “camera” polarizing filter placed between the image source and the concave semi-transparent reflector. Or vice versa the second polarizer 24 may be a wide width polarizing filter installed on the concave semi-transparent reflector, and the first polarizer 22 may be a matching “camera” polarizing filter placed between the image source and the concave semi-transparent reflector. The first polarizer 22 and the second polarizer 24 may be arranged parallel to each other. The first polarizer 22 may be configured to be rotated relative to the second polarizer to control the light. It may be the polarizer which is closest to the user(s), such as an audience, when in use, which is rotated. The first polarizer 22 may be closest to the user when the system is in use.

The polarizing filter 22 comprises a light sensor 26 which is configured to obtain light data, and configured to transmit the light data to a controller box 28. The controller box 28 is configured to receive the light data from the light sensor 26 and configured to control a motor 30. The motor 30 is configured to turn, such as rotate, the first polarizer 22 relative to the second polarizer 24.

The present invention provides a simple but yet effect-full exhibition system, capable of providing large virtual images without prior training even by persons without any technical skills. In this respect the invention provides a low cost, compact and customisable display.

Modifications and combinations of the above principles and designs are foreseen within the scope of the present invention.

1. An exhibition system for presenting a mixed reality, comprising:
one of a mechanism configured to hold an image source and an image source, wherein the image source is arranged for projecting at least one image onto at least one concave semi-transparent reflector providing a magnified representation of the image appearing in the distance beyond the semi-transparent reflector; and
adjustment means for adjusting at least one of a distance between the concave semi-transparent reflector and the image source and an angle between the concave semi-transparent reflector and the image source.

2. An exhibition system according to claim 1, wherein the magnified representation of the image behind said semi-transparent reflector is magnified at least 1.5 times the size of the image displayed by the image source, preferably at least 8 times, and even more preferably at least 2000 times the size of the image displayed by the image source.

3. An exhibition system according to claim 1, wherein the size of the concave semi-transparent reflector is between about 200×400 mm and about 12×24 m.

4. An exhibition system according to claim 3, wherein the size of the concave semi-transparent reflector is between about 200×400 mm and about 3000×3000 mm.

5. An exhibition system according to claim 4, wherein the concave semi-transparent reflector has an inner surface facing the image source with a radius of curvature between 800 mm and 80000 mm.

6. An exhibition system according to claim 5, wherein the concave semi-transparent reflector has an inner surface facing the image source with a radius of curvature between 2200 mm and 5000 mm, preferably about 2800 mm.

7. An exhibition system according to claim 1, wherein the inner and outer surfaces of the concave semi-transparent reflector (4) have substantially identical radii of curvature.

8. An exhibition system according to claim 1, wherein the system is arranged such that the distance between the concave semi-transparent reflector and the image source cannot exceed the focal length of the concave semi-transparent reflector.

9. An exhibition system according to claim 1, wherein a reflection layer of the semi-transparent reflector is the inner side of the concave semi-transparent reflector facing the image source.

10. An exhibition system according to claim 1, wherein the concave semi-transparent reflector is placed at an angle of between 5 and 25 degrees in relation to a surface or a base the system is placed upon.

11. An exhibition system according to claim 1, wherein the adjustment means is arranged for manually changing at least one of the distance and angle between the concave semi-transparent reflector and the image source.

12. An exhibition system according to claim 11, wherein said adjustment means comprises a connecter, to which the image source is attached, at least one longitudinal track in which the position of the connecter can be adjusted by slinging it back and forth along said track, and a fastening means for fastening the connecter at different positions along the track(s).

13. An exhibition system according to claim 1, wherein the adjustment means are arranged for automatically changing at least one of the distance and angle between the concave semi-transparent reflector and the image source.

14. An exhibition system according to claim 1, wherein the system comprises means for adjusting the transparency of the concave semi-transparent reflector, and wherein the transparency of said reflector can be adjusted from being completely opaque to being between about 30 and 50% transparent.

15. An exhibition system according to claim 14, wherein the concave semi-transparent reflector is arranged as a smart window.

16. An exhibition system according to claim 14, wherein the means for adjusting the transparency of the concave semitransparent reflector is a smart window behind the concave semi-transparent reflector seen in a position of use.

17. An exhibition system according to claim 14, wherein the means for adjusting the transparency of the concave semi-transparent reflector comprises at least one polarizing filter configured to be rotated to a rotational angle that controls the intensity of the light coming through the concave semi-transparent reflector.

18. An exhibition system according to claim 1, wherein the system comprises means for controlling the brightness of the image displayed by the image source.

19. An exhibition system according to claim 1, wherein the image source is a conventional display.

20. An exhibition system according to claim 1, wherein the image source is a concave image source.

21. An exhibition system according to claim 1, comprising at least two image sources, wherein at least one of the image sources is a concave semi-transparent image source.

22. An exhibition system according to claim 21, wherein the at least one concave semi-transparent image source has a radius of curvature corresponding substantially to a radius of curvature of the concave semi-transparent reflector.

23. An exhibition system according to claim 21, wherein the at least one concave semi-transparent image source has a radius of curvature which is smaller than a radius of curvature of the concave semi-transparent reflector.

24. An exhibition system according to claim 21, wherein the at least one concave semi-transparent image source has a radius of curvature which is substantially half of the radius of curvature of the concave semi-transparent reflector.

25. An exhibition system according to claim 21, wherein the adjustment means is configured to adjust the at least two image sources individually or in combination.

26. An exhibition system according to claim 21, wherein the at least two image sources have substantially the same focal point.

27. An exhibition system according to claim 21, wherein the system comprises one not-concave image source and one concave semi-transparent image source.

28. An exhibition system according to claim 21, wherein the at least one concave image source is a flexible OLED display.

29. An exhibition system according to claim 1, wherein the system is not a head mounting display.

30. An exhibition system according to claim 3, wherein the concave semi-transparent reflector is constructed by assembling a plurality of smaller-size concave semi-transparent reflectors.

31. A method for using the exhibition system according to claim 1, wherein at least one image displayed by an image source is projected onto a concave semi-transparent reflector thereby providing a magnified representation of the image appearing in the distance beyond the semi-transparent reflector, and wherein the degree of magnification and/or focus point is adjusted by adjusting at least one of the distance and angle between the concave semi-transparent reflector and the image source.

32. A method of using the exhibition system according to claim 31, wherein the method further comprises adjusting the transparency of the concave semi-transparent reflector from completely opaque to between about 30 and 50% transparency.

33. A movie display for presenting a mixed reality, said display comprising the exhibition system according to claim 1.

34. An exhibition display for presenting a mixed reality, said display comprising the exhibition system according to claim 1.

35. A method of using the exhibition system according to claim 1 comprising superimposing magnified representations onto the real-world.

36. A method of using the exhibition system according to claim 35, wherein said magnified representation has a size corresponding to the real-size of the object of the image display by the image source and/or a size that will be perceived as natural in relation to the surroundings.

37. A method of using the exhibition system according to claim 35, wherein the exhibition system is configured to be used in any exhibition context, such as a shop display, such as an advanced learning tool in a museum, such as outdoors, such as showing a new part of a city in development as an overlay on an existing city.
